(19) United States
(12) Patent Application Publication
(10) Pub. No.: US 2016/0027191 A1
(43) Pub. Date: Jan. 28, 2016

(54) METHOD AND DEVICE FOR ADJUSTING SKIN COLOR

(71) Applicant: Xiaomi Inc., Beijing (CN)

(72) Inventors: Lin WANG, Beijing (CN); Xiaozhou Xu, Beijing (CN); Zhijun Chen, Beijing (CN)

(73) Assignee: Xiaomi Inc.

(21) Appl. No.: 14/666,479

(22) Filed: Mar. 24, 2015

Related U.S. Application Data
(63) Continuation of application No. PCT/CN2014/091652, filed on Nov. 19, 2014.

(30) Foreign Application Priority Data
Jul. 23, 2014 (CN) 201410351282.X

(51) Int. Cl. G06T 11/00; G06T 7/40

(52) U.S. Cl. CPC G06T 11/001; G06T 7/401; G06T 7/408; G06T 2215/16; G06T 2207/20172

(57) ABSTRACT

A method for a device to adjust a skin color of an image includes: identifying a skin color region of the image; performing a statistical calculation on original color data of pixels in the skin color region to obtain an original mean value and an original standard deviation of the original color data of the pixels in the skin color region; selecting a preset skin color model from one or more preset skin color models each representing one skin color type, according to the original mean value and a preset mean value of each of the one or more preset skin color models; determining target color data according to the original color data, the original mean value, the original standard deviation, and the preset mean value and a preset standard deviation of the selected skin color model; and adjusting the skin color region according to the target color data.

### CROSS-REFERENCE TO RELATED APPLICATIONS

This application is a continuation of International Application No. PCT/CN2014/091652, filed Nov. 19, 2014, which is based upon and claims priority to Chinese Patent Application No. 201410351282.X, filed Jul. 23, 2014, the entire contents of all of which are incorporated herein by reference.

### TECHNICAL FIELD

The present disclosure relates to the field of image processing and, more particularly, to a method and a device for adjusting skin color.

### BACKGROUND

With the development of image processing technologies, mobile terminals generally provide a beautification function for captured images. Conventionally, when performing the beautification function on an image, a mobile terminal may adjust a skin color in the image according to a target color selected by a user, and convert the color in the skin color region of the image to the target color.

### SUMMARY

According to a first aspect of the present disclosure, there is provided a method for a device to adjust a skin color of an image, comprising: identifying a skin color region of the image; performing a statistical calculation on original color data of pixels in the skin color region to obtain an original mean value and an original standard deviation of the original color data of the pixels in the skin color region; selecting a preset skin color model from one or more preset skin color models each representing one skin color type, according to the original mean value and a preset mean value of each of the one or more preset skin color models; determining target color data according to the original color data, the original mean value, the original standard deviation, and the preset mean value and a preset standard deviation of the selected skin color model; and adjusting the skin color region according to the target color data.

According to a second aspect of the present disclosure, there is provided a device, comprising: a processor; and a memory for storing instructions executable by the processor; wherein the processor is configured to: identify a skin color region of an image; perform a statistical calculation on original color data of pixels in the skin color region to obtain an original mean value and an original standard deviation of the original color data of the pixels in the skin color region; select a preset skin color model from one or more preset skin color models each representing one skin color type, according to the original mean value and a preset mean value of each of the one or more preset skin color models; determine target color data according to the original color data, the original mean value, the original standard deviation, and the preset mean value and a preset standard deviation of the selected skin color model; and adjust the skin color region according to the target color data.

According to a third aspect of the present disclosure, there is provided a non-transitory computer-readable storage medium having instructions stored therein which, when executed by a processor of a device, cause the device to perform a method for adjusting a skin color of an image, the method comprising: identifying a skin color region of the image; performing a statistical calculation on original color data of pixels in the skin color region to obtain an original mean value and an original standard deviation of the original color data of the pixels in the skin color region; selecting a preset skin color model from one or more preset skin color models each representing one skin color type, according to the original mean value and a preset mean value of each of the one or more preset skin color models, determining target color data according to the original color data, the original mean value, the original standard deviation, and the preset mean value and a preset standard deviation of the selected skin color model; and adjusting the skin color region according to the target color data.

It shall be appreciated that the above general description and the detailed description hereinafter are only illustrative but not for limiting the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for adjusting a skin color of an image, according to an exemplary embodiment.

FIG. 2 is a flow chart of a method for adjusting a skin color of an image, according to an exemplary embodiment.

FIG. 3 is a block diagram of a device for adjusting a skin color of an image, according to an exemplary embodiment.

FIG. 4 is a block diagram of a device for adjusting a skin color of an image, according to an exemplary embodiment.

FIG. 5 is a block diagram of a device for adjusting a skin color of an image, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

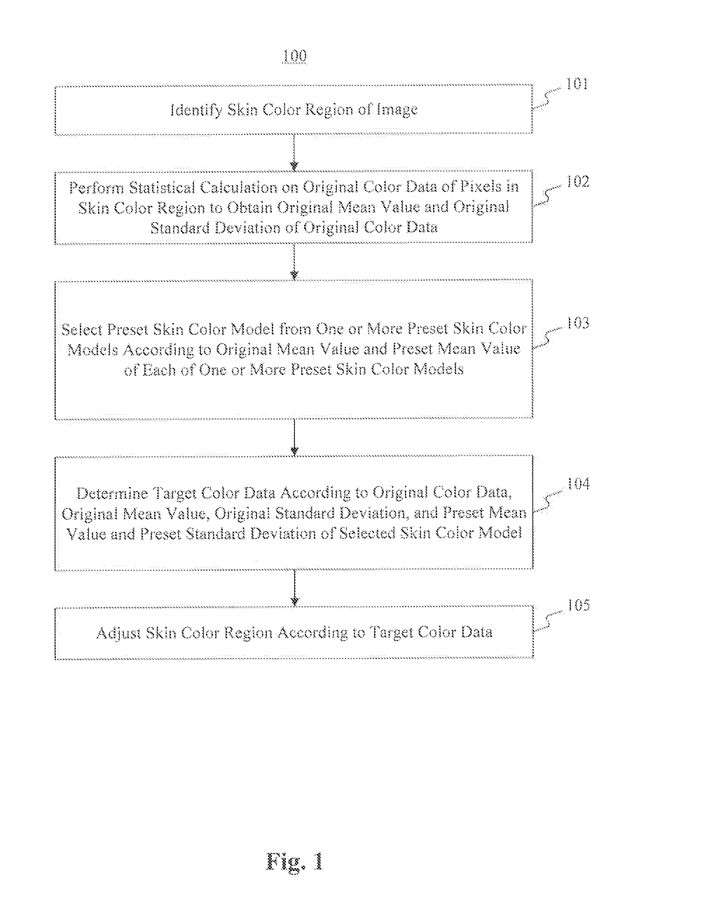

FIG. 1 is a flow chart of a method 100 for a device to adjust a skin color in an image, according to an exemplary embodiment. Referring to FIG. 1, the method 100 includes the following steps.

In step 101, the device identifies a skin color region of an image.

In step 102, the device performs a statistical calculation on original color data of pixels in the skin color region, to obtain an original mean value and an original standard deviation of the original color data of the pixels in the skin color region.

In step 103, the device selects a preset skin color model, determined to be most similar to the skin color region, from one or more preset skin color models each representing one skin color type, according to the original mean value and a preset mean value of each of the one or more preset skin color models.

In step 104, the device determines target color data according to the original color data, the original mean value, the original standard deviation, and the preset mean value and a preset standard deviation of the selected skin color model.

In step 105, the device adjusts the skin color region according to the target color data.

In the illustrated embodiment, when the skin color region is adjusted on the basis of the selected skin color model, a difference between the adjusted skin color and an actual skin color is decreased, image distortion can be avoided, and the beautification effect is improved. Further, a user does not need to select a target color, and thus user operation is convenient.

In one exemplary embodiment, the device selects the preset skin color model from a plurality of preset skin color models. Accordingly, the device calculates a difference between the original mean value of the original color data of the pixels in the skin color region and a preset mean value of each of the plurality of preset skin color models; and selects the preset skin color model from the plurality of preset skin color models, the difference between the preset mean value of the selected skin color model and the original mean value being smallest.

In one exemplary embodiment, the device selects the preset skin color model from a plurality of preset skin color models. Accordingly, the device calculates an Euclidean distance between the original mean value of the original color data of the pixels in the skin color region and a preset mean value of each of the plurality of preset skin color models; and selects the preset skin color model from the plurality of preset skin color models, the Euclidean distance between the preset mean value of the selected skin color model and the original mean value being smallest.

In one exemplary embodiment, the original color data is YUV data. Accordingly, to determine the target color data for each pixel in the skin color region, the device determines the target color data of the pixel according to original color data of the pixel, the original mean value, and the original standard deviation, and the preset mean value and the preset standard deviation of the selected skin color model based on equations (1), as follows:

$${Y}^{*} = {meanY}_{iType} + \frac{{deltaY}_{iType} * ( Y - meanY )}{deltaY} ; \\ {U}^{*} = {meanU}_{iType} + \frac{{deltaU}_{iType} * ( U - meanU )}{deltaU} ; and \\ {V}^{*} = {meanV}_{iType} + \frac{{deltaV}_{iType} * ( V - meanV )}{deltaV} , \qquad equations ( 1 )$$

In the illustrated embodiment, (̅Y̅,̅U̅,̅V̅)̅ is the original color data of the pixel, Y is a value of the original color data on a dimension Y in a YUV space, U is a value of the original color data on a dimension U in the YUV space, and V is a value of the original color data on a dimension V in the YUV space.

In the illustrated embodiment, (̅Y̅*̅,̅U̅*̅,̅V̅*̅)̅ is the target color data of the pixel, Y* is a value of the target color data on the dimension Y in the YUV space, U* is a value of the target color data on the dimension U in the YUV space, and V* is a value of the target color data on the dimension V in the YUV space.

In the illustrated embodiment, (̅m̅e̅a̅n̅Y̅,̅m̅e̅a̅n̅U̅,̅m̅e̅a̅n̅V̅)̅ is the original mean value, meanY is a value of the original mean value on the dimension Y in the YUV space, meanU is a value of the original mean value on the dimension U in the YUV space, and meanV is a value of the original mean value on the dimension V in the YUV space.

In the illustrated embodiment, (̅d̅e̅l̅t̅a̅Y̅,̅d̅e̅l̅t̅a̅U̅,̅d̅e̅l̅t̅a̅V̅)̅ is the original standard deviation, deltaY is a value of the original standard deviation on the dimension Y in the YUV space, deltaU is a value of the original standard deviation on the dimension U in the YUV space, and deltaV is a value of the original standard deviation on the dimension V in the YUV space.

In the illustrated embodiment, (̅m̅e̅a̅n̅Y̅_̅{̅i̅T̅y̅p̅e̅}̅,̅m̅e̅a̅n̅U̅_̅{̅i̅T̅y̅p̅e̅}̅,̅m̅e̅a̅n̅V̅_̅{̅i̅T̅y̅p̅e̅}̅)̅ is the preset mean value of the selected skin color model, meanY_{iType} is a value of the preset mean value on the dimension Y in the YUV space, meanU_{iType} is a value of the preset mean value on the dimension U in the YUV space, and meanV_{iType} is a value of the preset mean value on the dimension V in the YUV space.

In the illustrated embodiment, (̅d̅e̅l̅t̅a̅Y̅_̅{̅i̅T̅y̅p̅e̅}̅,̅d̅e̅l̅t̅a̅U̅_̅{̅i̅T̅y̅p̅e̅}̅,̅d̅e̅l̅t̅a̅V̅_̅{̅i̅T̅y̅p̅e̅}̅)̅ is the preset standard deviation of the selected skin color model, deltaY_{iType} is a value of the preset standard deviation on the dimension Y in the YUV space, deltaU_{iType} is a value of the preset standard deviation on the dimension U in the YUV space, and deltaV_{iType} is a value of the preset standard deviation on the dimension V in the YUV space.

In one exemplary embodiment, to adjust the skin color region according to the target color data, the device adjusts the original color data of each pixel in the skin color region to be the target color data of each pixel.

In one exemplary embodiment, the device presets a first preset skin color model, a second preset skin color model, a third preset skin color model, a fourth preset skin color model, a fifth preset skin color model, and a sixth preset skin color model.

A preset mean value and a preset standard deviation of the first preset skin color model are obtained by performing a statistical calculation on color data of sample images of light white people. A preset mean value and a preset standard deviation of the second preset skin color model are obtained by performing a statistical calculation on color data of sample images of dark white people. A preset mean value and a preset standard deviation of the third preset skin color model are obtained by performing a statistical calculation on color data of sample images of light yellow people. A preset mean value and a preset standard deviation of the fourth preset skin color model are obtained by performing a statistical calculation on color data of sample images of dark yellow people. A preset mean value and a preset standard deviation of the fifth preset skin color model are obtained by performing a statistical calculation on color data of sample images of light black people. A preset mean value and a preset standard deviation of the sixth preset skin color model are obtained by performing a statistical calculation on color data of sample images of dark black people.

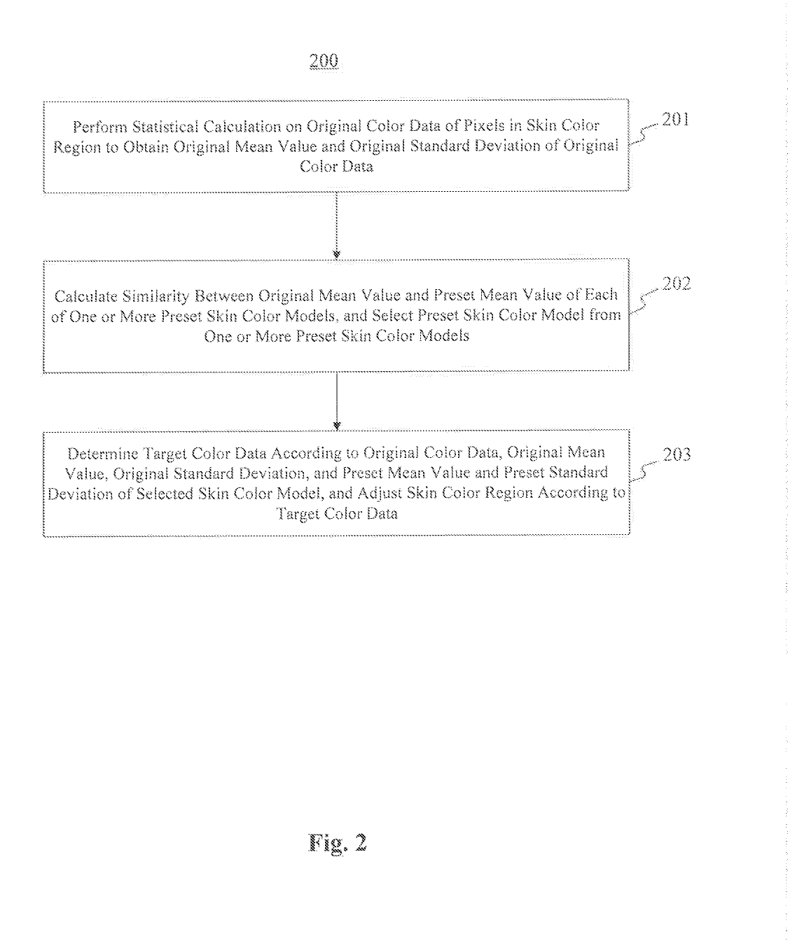

FIG. 2 is a flow chart of a method 200 for adjusting a skin color of an image, according to an exemplary embodiment. For example the method 200 is used in a server. Referring to FIG. 2, the method 200 includes the following steps.

In step 201, the server identifies a skin color region of an image, and performs a statistical calculation on original color data of pixels in the skin color region to obtain an original mean value and an original standard deviation of the original color data of the pixels in the skin color region.

In exemplary embodiments, the image may be an image captured by a terminal and uploaded to the server, or an image transmitted from another server. For example, the image includes the skin color region, such as a face region, an entire-body region, and the like, which are not limited in the embodiment. When the terminal captures the image, the terminal may automatically upload the image to the server. The server adjusts the skin color of the image and transmits the adjusted image to the terminal, and then the terminal directly displays the adjusted image. Alternatively, the terminal displays the captured image and, when the user inputs an instruction for adjusting the skin color of the image, the terminal uploads the image to the server. The server then adjusts the skin color of the image, and transmits the adjusted image to the terminal, so that the terminal displays the adjusted image.

In exemplary embodiments, the server uses a skin color detection algorithm to identify the image, and selects sample pixels of the image according to a skin color detection operator. The server further performs a color modeling on the skin color by using a Gaussian mixture model, and uses the established color model to classify the skin color region and a non-skin color region in the image, thereby to obtain the skin color region of the image. The server may identify a plurality of skin color regions of the image, for example, a forehead skin color region, a cheek skin color region, a nosewing skin color region, and the like. The server further adjusts the skin color of each of the skin color regions. In the illustrated embodiment, only one skin color region of the image is taken as an example for illustrative purposes only.

In exemplary embodiments, the sever may select a plurality of sample pixels in the skin color region, acquire original color data of each sample pixel, and perform a statistical calculation on the original color data of the plurality of sample pixels to obtain a mean value and a standard deviation of the original color data of the plurality of sample pixels, as the original mean value and the original standard deviation of the pixels in the skin color region, respectively.

In one exemplary embodiment, the original color data is YUV data. For example, the original mean value acquired by the server is (̅m̅e̅a̅n̅Y̅,̅m̅e̅a̅n̅U̅,̅m̅e̅a̅n̅V̅)̅, and the original standard deviation acquired by the server is (̅d̅e̅l̅t̅a̅Y̅,̅d̅e̅l̅t̅a̅U̅,̅d̅e̅l̅t̅a̅V̅)̅. In the three-dimensional space of the YUV, a detection result of the skin color region can be an ellipsoid, the original mean value corresponding to a center of the ellipsoid, and the three elements in the original standard deviation corresponding to three spherical radiuses of the ellipsoid.

In step 202, the server calculates a similarity between the original mean value and a preset mean value of each of one or more preset skin color models, and selects a preset skin color model from the one or more preset skin color models, the similarity between the preset mean value of the selected skin color model and the original mean value being smallest.

In the illustrated embodiment, to improve the accuracy of adjusting the skin color, the server establishes the one or more preset skin color models in advance to obtain a preset mean value and a preset standard deviation of each of the one or more preset skin color models. Each preset skin color model represents one skin color type. The server may select a preset skin color type most similar to the skin color region according to the similarity between the original mean value of the original color data of the skin color region and the preset mean value of each of the one or more preset skin color models. When the skin color is adjusted on the basis of the selected skin color type, a difference between the adjusted skin color and the actual skin color may be decreased, and image distortion may be avoided.

Accordingly, before step 202, the method 200 may further include establishing the one or more preset skin color models by the server. For example, the server selects sample images of different skin color types; with respect to each skin color type, the server performs training, a statistical calculation, and modeling on color data of a plurality of sample images corresponding to the skin color type, to obtain a preset skin color model corresponding to the skin color type as well as a mean value and a standard deviation of the preset skin color model as the preset mean value and the preset standard deviation of the preset skin color model, respectively. The statistical calculation performed on each sample image is similar to step 201. In the three-dimensional space of the YUV, a preset skin color model can be an ellipsoid, the preset mean value corresponding to a center of the ellipsoid, and the three elements in the preset standard deviation corresponding to three spherical radiuses of the ellipsoid.

Further, the server may perform the statistical calculation offline on the color data of the plurality of sample images. When the preset mean value and the preset standard deviation of a preset skin color model are acquired, the color data of the sample images is deleted so as to save storage space.

In exemplary embodiment, an image is selected as a sample image if a skin color region in the image is clear and beautiful so as to ensure that, when the skin color of the skin color region is subsequently adjusted on the basis of the corresponding skin color model, the adjusted skin color region may not distort, and can meet the beautification demand of the user.

For example, human skin color types may include light white, dark white, light yellow, dark yellow, light black, and dark black. The server performs statistical calculations on the sample images corresponding to the foregoing six skin color types, to establish six preset skin color models including: a first preset skin color model, a second preset skin color model, a third preset skin color model, a fourth preset skin color model, a fifth preset skin color model and a sixth preset skin color model. A preset mean value and a preset standard deviation of the first preset skin color model are obtained by performing a statistical calculation on color data of sample images of light white people. A preset mean value and a preset standard deviation of the second preset skin color model are obtained by performing a statistical calculation on color data of sample images of dark white people. A preset mean value and a preset standard deviation of the third preset skin color model are obtained by performing a statistical calculation on color data of sample images of light yellow people. A preset mean value and a preset standard deviation of the fourth preset skin color model are obtained by performing a statistical calculation on color data of sample images of dark yellow people. A preset mean value and a preset standard deviation of the fifth preset skin color model are obtained by performing a statistical calculation on color data of sample images of light black people. A preset mean value and a preset standard deviation of the sixth preset skin color model are obtained by performing a statistical calculation on color data of sample images of dark black people.

In one exemplary embodiment, the server calculates a similarity between the original mean value of the original color data of the skin color region and the preset mean value of each of the one or more preset skin color models. A larger similarity indicates that the skin color region is more similar to the corresponding preset skin color model. Then the server selects, from the one or more preset skin color models, a preset skin color model having a preset mean value which has a largest similarity with the original mean value, as the selected skin color model, which is the preset skin color model determined to be most similar to the skin color region. For example, when the skin color region is a skin color region of light yellow people, the server calculates a similarity between the original mean value of the original color data of the skin color region and a preset mean value of each of first, second, and third preset skin color models, and determines that the similarity between the preset mean value of the third preset skin color model and the original mean value is the largest. Accordingly, the third preset skin color model is selected, and the skin color of the skin color region is adjusted on the basis of the third preset skin color model.

In one exemplary embodiment, the server calculates a Euclidean distance between the original mean value and the preset mean value of each of the one or more preset skin color models. A smaller Euclidean distance indicates that the skin color region is more similar to the corresponding preset skin color model. Thus, a preset skin color model having a preset mean value which has a smallest Euclidean distance to the original mean value is selected from the one or more preset skin color models. For example, the preset skin color model is selected based on equation (2), as follows:

iType=arg min(dist( (̅m̅e̅a̅n̅Y̅,̅m̅e̅a̅n̅U̅,̅m̅e̅a̅n̅V̅)̅, (̅m̅e̅a̅n̅Y̅ᵢ̅,̅m̅e̅a̅n̅U̅ᵢ̅,̅m̅e̅a̅n̅V̅ᵢ̅)̅)) equation (2),

where (̅m̅e̅a̅n̅Y̅,̅m̅e̅a̅n̅U̅,̅m̅e̅a̅n̅V̅)̅ is the original mean value, (̅m̅e̅a̅n̅Y̅ᵢ̅,̅m̅e̅a̅n̅U̅ᵢ̅,̅m̅e̅a̅n̅V̅ᵢ̅)̅ is a preset mean value of an i^{th} preset skin color model, i=1, 2 . . . n, n being a number of the preset skin color models, dist(ā, b̅) is the Euclidean distance between two vectors ā and b̅, iType is the selected skin color model, and the Euclidean distance between the preset mean value of the selected skin color model and the original mean value is smallest.

In one exemplary embodiment, the server calculates a cosine similarity between the original mean value of the original color data of the skin color region and the preset mean value of each of the one or more preset skin color models. A larger cosine similarity indicates that the skin color region is more similar to the corresponding preset skin color model. Accordingly, a preset skin color model having a preset mean value which has a largest cosine similarity with the original mean value is selected from the one or more preset skin color models. Methods to calculate the similarity are not limited in the embodiments.

In one exemplary embodiment, the server may also calculate a difference between the original mean value of the original color data of the skin color region and the preset mean value of each of the one or more preset skin color models. A smaller difference indicates that the skin color region is more similar to the corresponding preset skin color model. Accordingly, a preset skin color model having a preset mean value which has a smallest difference from the original mean value is selected from the one or more preset skin color models.

In step 203, the server determines target color data according to the original color data, the original mean value, the original standard deviation, and the preset mean value and the preset standard deviation of the selected skin color model, and adjusts the skin color region according to the target color data.

In one exemplary embodiment, the original color data is YUV data. Accordingly, for each pixel in the skin color region, the server determines the target color data of the pixel according to original color data of the pixel, the original mean value, and the original standard deviation, and the preset mean value and the preset standard deviation of the designated skin color model based on equations (3), as follows:

$$\frac{Y - meanY}{deltaY} = \frac{{Y}^{*} - {meanY}_{iType}}{{deltaY}_{iType}} ; \\ \frac{U - meanU}{deltaU} = \frac{{U}^{*} - {meanU}_{iType}}{{deltaU}_{iType}} ; and \\ \frac{V - meanV}{deltaV} = \frac{{V}^{*} - {meanV}_{iType}}{{deltaV}_{iType}} . \qquad equations ( 3 )$$

In the illustrated embodiment, (̅Y̅,̅U̅,̅V̅)̅ is the original color data of the pixel, Y is a value of the original color data on a dimension Y in a YUV space, U is a value of the original color data on a dimension U in the YUV space, and V is a value of the original color data on a dimension V in the YUV space.

In the illustrated embodiment, (Y*,U*,V*) is the target color data of the pixel, Y* is a value of the target color data on the dimension Y in the YUV space, U* is a value of the target color data on the dimension U in the YUV space, and V* is a value of the target color data on the dimension V in the YUV space.

In the illustrated embodiment, (̅m̅e̅a̅n̅Y̅,̅m̅e̅a̅n̅U̅,̅m̅e̅a̅n̅V̅)̅ is the original mean value, meanY is a value of the original mean value on the dimension Y in the YUV space, meanU is a value of the original mean value on the dimension U in the YUV space, and meanV is a value of the original mean value on the dimension V in the YUV space.

In the illustrated embodiment. (̅d̅e̅l̅t̅a̅Y̅,̅d̅e̅l̅t̅a̅U̅,̅d̅e̅l̅t̅a̅V̅)̅ is the original standard deviation, deltaY is a value of the original standard deviation on the dimension Y in the YUV space, deltaU is a value of the original standard deviation on the dimension U in the YUV space, and deltaV is a value of the original standard deviation on the dimension V in the YUV space.

In the illustrated embodiment, (̅m̅e̅a̅n̅Y̅_̅{̅i̅T̅y̅p̅e̅}̅,̅m̅e̅a̅n̅U̅_̅{̅i̅T̅y̅p̅e̅}̅,̅m̅e̅a̅n̅V̅_̅{̅i̅T̅y̅p̅e̅}̅)̅ is the preset mean value of the selected skin color model, meanY_{iType} is a value of the preset mean value on the dimension Y in the YUV space, meanU_{iType} is a value of the preset mean value on the dimension U in the YUV space, and meanV_{iType} is a value of the preset mean value on the dimension V in the YUV space.

In the illustrated embodiment, (̅d̅e̅l̅t̅a̅Y̅_̅{̅i̅T̅y̅p̅e̅}̅,̅d̅e̅l̅t̅a̅U̅_̅{̅i̅T̅y̅p̅e̅}̅,̅d̅e̅l̅t̅a̅V̅_̅{̅i̅T̅y̅p̅e̅}̅)̅ is the preset standard deviation of the selected skin color model, deltaY_{iType} is a value of the preset standard deviation on the dimension Y in the YUV space, deltaU_{iType} is a value of the preset standard deviation on the dimension U in the YUV space, and deltaV_{iType} is a value of the preset standard deviation on the dimension V in the YUV space.

In one exemplary embodiment, the server determines the target color data of the pixel based on equations (I), reproduced below:

$${Y}^{*} = {meanY}_{iType} + \frac{{deltaY}_{iType} * ( Y - meanY )}{deltaY} ; \\ {U}^{*} = {meanU}_{iType} + \frac{{deltaU}_{iType} * ( U - meanU )}{deltaU} ; and \\ {V}^{*} = {meanV}_{iType} + \frac{{deltaV}_{iType} * ( V - meanV )}{deltaV} . \qquad equations ( 1 )$$

After determining the target color data of each pixel in the skin color region, the server adjusts the original color data of each pixel to be the corresponding target color data, thus implementing the skin color adjustment.

It should be noted that the above embodiment is illustrated by taking the server as an example. The method 200 may also be performed by a terminal. For example, the terminal downloads the preset mean value and the preset standard deviation of at least one-preset skin color model established by the server. When the terminal captures an image, the terminal applies the method 200 to adjust the skin color of a skin color region of the image.

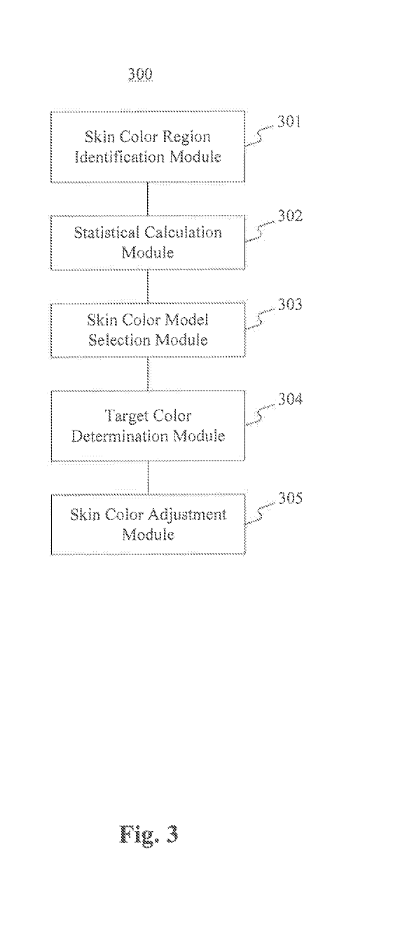

FIG. 3 is a block diagram of a device 300 for adjusting a skin color of an image, according to an exemplary embodiment. Referring to FIG. 3, the device 300 includes a skin color region identification module 301, a statistical calculation module 302, a skin color model selection module 303, a target color determination module 304, and a skin color adjustment module 305.

The skin color region identification module 301 is configured to identify a skin color region of an image.

The statistical calculation module 302 is configured to perform a statistical calculation on original color data of pixels in the skin color region to obtain an original mean value and an original standard deviation of the original color data of the pixels in the skin color region.

The skin color model selection module 303 is configured to select a preset skin color model, determined to be most similar to the skin color region, from one or more preset skin color models each representing one skin color type, according to the original mean value and a preset mean value of each of the one or more preset skin color models.

The target color determination module 304 is configured to determine target color data according to the original color data, the original mean value, the original standard deviation, and the preset mean value and a preset standard deviation of the selected skin color model.

The skin color adjustment module 305 is configured to adjust the skin color region according to the target color data.

The skin color region identification module 301, the statistical calculation module 302, the skin color model selection module 303, the target color determination module 304, and the skin color adjustment module 305 are configured to perform steps described above in connection with the methods 100 (FIG. 1) and 200 (FIG. 2).

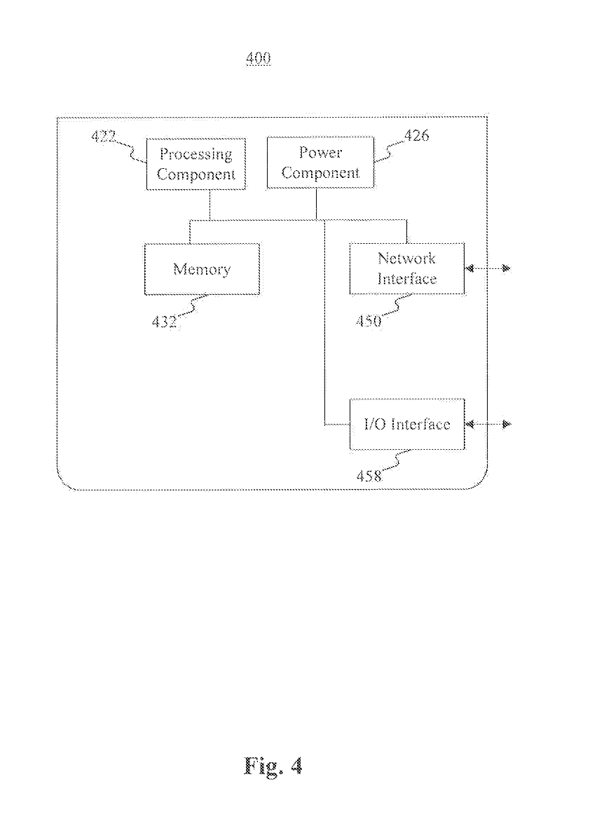

FIG. 4 is a block diagram of a device 400 for adjusting a skin color in an image, according to an exemplary embodiment. For example, the device 400 may be provided as a server. Referring to FIG. 4, the device 400 includes a processing component 422 that further includes one or more processors, and memory resources represented by a memory 432 for storing instructions executable by the processing component 422, such as application programs. The application programs stored in the memory 432 may include one or more modules each corresponding to a set of instructions. Further, the processing component 422 is configured to execute the instructions to perform the above described methods.

The device 400 may also include a power component 426 configured to perform power management of the device 400, wired or wireless network interface(s) 450 configured to connect the device 400 to a network, and an input/output (I/O) interface 458. The device 400 may operate based on an operating system stored in the memory 432, such as Windows Server™, Mac OS X™, Unix™, Linux™, FreeBSD™, or the like.

In exemplary embodiments, there is also provided a non-transitory computer-readable storage medium including instructions, such as included in the memory 432, executable by the processing component 422 in the device 400, for performing the above-described methods. For example, the non-transitory computer-readable storage medium may be a ROM, a RAM, a CD-ROM, a magnetic tape, a floppy disc, an optical data storage device, and the like.

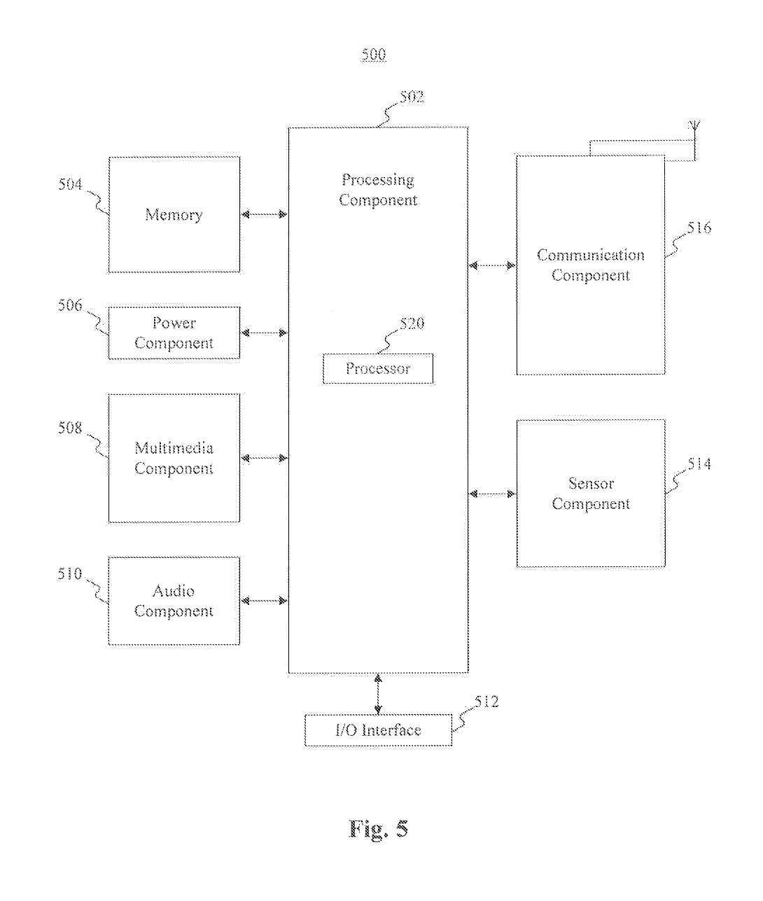

FIG. 5 is a block diagram of a device 500 for adjusting a skin color in an image, according to an exemplary embodiment. For example, the device 500 may be a mobile phone, a computer, a digital broadcast terminal, a messaging device, a gaming console, a tablet, a medical device, exercise equipment, a personal digital assistant, and the like.

Referring to FIG. 5, the device 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the device 500, such as the operations associated with display, telephone calls, data communications, camera operations, and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the device 500. Examples of such data include instructions for any applications or methods operated on the device 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power sources, and any other components associated with the generation, management, and distribution of power in the device 500.

The multimedia component 508 includes a screen providing an output interface between the device 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and/or the rear camera may receive an external multimedia datum while the device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone configured to receive an external audio signal when the device 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the device 500. For instance, the sensor component 514 may detect an open/closed status of the device 500, relative positioning of components. e.g., the display and the keypad, of the device 500, a change in position of the device 500 or a component of the device 500, a presence or absence of user contact with the device 500, an orientation or an acceleration/deceleration of the device 500, and a change in temperature of the device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the device 500 and other devices. The device 500 can access a wireless network based on a communication standard, such as WiFi, 2G, or 3G, or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 604, executable by the processor 620 in the device 600, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for a device to adjust a skin color of an image, comprising:
identifying a skin color region of the image;
performing a statistical calculation on original color data of pixels in the skin color region to obtain an original mean value and an original standard deviation of the original color data of the pixels in the skin color region;
selecting a preset skin color model from one or more preset skin color models each representing one skin color type, according to the original mean value and a preset mean value of each of the one or more preset skin color models;
determining target color data according to the original color data, the original mean value, the original standard deviation, and the preset mean value and a preset standard deviation of the selected skin color model; and
adjusting the skin color region according to the target color data.

2. The method according to claim 1, wherein the selecting of the preset skin color model comprises:
calculating a difference between the original mean value and the preset mean value of each of the one or more preset skin color models; and
selecting the preset skin color model from the one or more preset skin color models, the difference between the preset mean value of the selected skin color model and the original mean value being smallest.

3. The method according to claim 1, wherein the selecting of the preset skin color model comprises:
calculating an Euclidean distance between the original mean value and the preset mean value of each of the one or more preset skin color models; and
selecting the preset skin color model from the one or more preset skin color models, the Euclidean distance between the preset mean value of the selected skin color model and the original mean value being smallest.

4. The method according to claim 1, wherein the original color data is YUV data, and the determining of the target color data comprises:
determining, for each pixel in the skin color region, the target color data of the pixel according to original color data of the pixel, the original mean value, the original standard deviation, and the preset mean value and the preset standard deviation of the selected skin color model based on the following equations:
$${Y}^{*} = {meanY}_{iType} + \frac{{deltaY}_{iType} * ( Y - meanY )}{deltaY} ;$$
$${U}^{*} = {meanU}_{iType} + \frac{{deltaU}_{iType} * ( U - meanU )}{deltaU} ; and$$
$${V}^{*} = {meanV}_{iType} + \frac{{deltaV}_{iType} * ( V - meanV )}{deltaV} ;$$
wherein the original color data of the pixel is represented by (̅Y̅,̅U̅,̅V̅)̅, Y is a value of the original color data on a dimension Y in a YUV space, U is a value of the original color data on a dimension U in the YUV space, and V is a value of the original color data on a dimension V in the YUV space;
the target color data of the pixel is represented by (̅Y̅*̅,̅U̅*̅,̅Y̅*̅)̅, Y* is a value of the target color data on the dimension Y in the YUV space, U* is a value of the target color data on the dimension U in the YUV space, and V* is a value of the target color data on the dimension V in the YUV space;
the original mean value is represented by (̅m̅e̅a̅n̅Y̅,̅m̅e̅a̅n̅U̅,̅m̅e̅a̅n̅V̅)̅, meanY is a value of the original mean value on the dimension Y in the YUV space, meanU is a value of the original mean value on the dimension U in the YUV space, and meanV is a value of the original mean value on the dimension V in the YUV space;
the original standard deviation is represented by (̅d̅e̅l̅t̅a̅Y̅,̅d̅e̅l̅t̅a̅U̅,̅d̅e̅l̅t̅a̅V̅)̅, deltaY is a value of the original standard deviation on the dimension Y in the YUV space, deltaU is a value of the original standard deviation on the dimension U in the YUV space, and deltaV is a value of the original standard deviation on the dimension V in the YUV space;
the preset mean value of the selected skin color model is represented by (meanY_{iType},meanU_{iType},meanV_{iType}), meanY_{iType} is a value of the preset mean value on the dimension Y in the YUV space, meanU_{iType} is a value of the preset mean value on the dimension U in the YUV space, and meanV_{iType} is a value of the preset mean value on the dimension V in the YUV space; and
the preset standard deviation of the selected skin color model is represented by (̅d̅e̅l̅t̅a̅Y̅_̅{̅i̅T̅y̅p̅e̅}̅,̅d̅e̅l̅t̅a̅U̅_̅{̅i̅T̅y̅p̅e̅}̅,̅d̅e̅l̅t̅a̅V̅_̅{̅i̅T̅y̅p̅e̅}̅)̅, deltaY_{iType} is a value of the preset standard deviation on the dimension Y in the YUV space, deltaU_{iType} is a value of the preset standard deviation on the dimension U in the YUV space, and deltaV_{iType} is a value of the preset standard deviation on the dimension V in the YUV space.

5. The method according to claim 4, wherein the adjusting of the skin color region according to the target color data comprises:
adjusting the original color data of each pixel in the skin color region to be the target color data of each pixel.

6. The method according to claim 1, further comprising:
establishing the one or more preset skin color models including a first preset skin color model, a second preset skin color model, a third preset skin color model, a fourth preset skin color model, a fifth preset skin color model, and a sixth preset skin color model, wherein:
a preset mean value and a preset standard deviation of the first preset skin color model are obtained by performing a statistical calculation on color data of sample images of light white people;
a preset mean value and a preset standard deviation of the second preset skin color model are obtained by performing a statistical calculation on color data of sample images of dark white people;
a preset mean value and a preset standard deviation of the third preset skin color model are obtained by performing a statistical calculation on color data of sample images of light yellow people;
a preset mean value and a preset standard deviation of the fourth preset skin color model are obtained by performing a statistical calculation on color data of sample images of dark yellow people;
a preset mean value and a preset standard deviation of the fifth preset skin color model are obtained by performing a statistical calculation on color data of sample images of light black people; and
a preset mean value and a preset standard deviation of the sixth preset skin color model are obtained by performing a statistical calculation on color data of sample images of dark black people.

7. The method according to claim 2, further comprising:
establishing the one or more preset skin color models including a first preset skin color model, a second preset skin color model, a third preset skin color model, a fourth preset skin color model, a fifth preset skin color model, and a sixth preset skin color model, wherein:
a preset mean value and a preset standard deviation of the first preset skin color model are obtained by performing a statistical calculation on color data of sample images of light white people;
a preset mean value and a preset standard deviation of the second preset skin color model are obtained by performing a statistical calculation on color data of sample images of dark white people;
a preset mean value and a preset standard deviation of the third preset skin color model are obtained by performing a statistical calculation on color data of sample images of light yellow people;
a preset mean value and a preset standard deviation of the fourth preset skin color model are obtained by performing a statistical calculation on color data of sample images of dark yellow people;
a preset mean value and a preset standard deviation of the fifth preset skin color model are obtained by performing a statistical calculation on color data of sample images of light black people; and
a preset mean value and a preset standard deviation of the sixth preset skin color model are obtained by performing a statistical calculation on color data of sample images of dark black people.

8. The method according to claim 3, further comprising:
establishing the one or more preset skin color models including a first preset skin color model, a second preset skin color model, a third preset skin color model, a fourth preset skin color model, a fifth preset skin color model, and a sixth preset skin color model, wherein:
a preset mean value and a preset standard deviation of the first preset skin color model are obtained by performing a statistical calculation on color data of sample images of light white people;
a preset mean value and a preset standard deviation of the second preset skin color model are obtained by performing a statistical calculation on color data of sample images of dark white people;
a preset mean value and a preset standard deviation of the third preset skin color model are obtained by performing a statistical calculation on color data of sample images of light yellow people;
a preset mean value and a preset standard deviation of the fourth preset skin color model are obtained by performing a statistical calculation on color data of sample images of dark yellow people;
a preset mean value and a preset standard deviation of the fifth preset skin color model are obtained by performing a statistical calculation on color data of sample images of light black people; and
a preset mean value and a preset standard deviation of the sixth preset skin color model are obtained by performing a statistical calculation on color data of sample images of dark black people.

9. The method according to claim 4, further comprising:
establishing the one or more preset skin color models including a first preset skin color model, a second preset skin color model, a third preset skin color model, a fourth preset skin color model, a fifth preset skin color model, and a sixth preset skin color model, wherein:
a preset mean value and a preset standard deviation of the first preset skin color model are obtained by performing a statistical calculation on color data of sample images of light white people;
a preset mean value and a preset standard deviation of the second preset skin color model are obtained by performing a statistical calculation on color data of sample images of dark white people;
a preset mean value and a preset standard deviation of the third preset skin color model are obtained by performing a statistical calculation on color data of sample images of light yellow people;
a preset mean value and a preset standard deviation of the fourth preset skin color model are obtained by performing a statistical calculation on color data of sample images of dark yellow people;
a preset mean value and a preset standard deviation of the fifth preset skin color model are obtained by performing a statistical calculation on color data of sample images of light black people; and
a preset mean value and a preset standard deviation of the sixth preset skin color model are obtained by performing a statistical calculation on color data of sample images of dark black people.

10. The method according to claim 5, further comprising:
establishing the one or more preset skin color models including a first preset skin color model, a second preset skin color model, a third preset skin color model, a fourth preset skin color model, a fifth preset skin color model, and a sixth preset skin color model, wherein:
a preset mean value and a preset standard deviation of the first preset skin color model are obtained by performing a statistical calculation on color data of sample images of light white people;
a preset mean value and a preset standard deviation of the second preset skin color model are obtained by performing a statistical calculation on color data of sample images of dark white people;
a preset mean value and a preset standard deviation of the third preset skin color model are obtained by performing a statistical calculation on color data of sample images of light yellow people;
a preset mean value and a preset standard deviation of the fourth preset skin color model are obtained by performing a statistical calculation on color data of sample images of dark yellow people;
a preset mean value and a preset standard deviation of the fifth preset skin color model are obtained by performing a statistical calculation on color data of sample images of light black people; and
a preset mean value and a preset standard deviation of the sixth preset skin color model are obtained by performing a statistical calculation on color data of sample images of dark black people.

11. A device, comprising:
a processor; and
a memory for storing instructions executable by the processor;
wherein the processor is configured to:
identify a skin color region of an image;
perform a statistical calculation on original color data of pixels in the skin color region to obtain an original mean value and an original standard deviation of the original color data of the pixels in the skin color region;
select a preset skin color model from one or more preset skin color models each representing one skin color type, according to the original mean value and a preset mean value of each of the one or more preset skin color models;
determine target color data according to the original color data, the original mean value, the original standard deviation, and the preset mean value and a preset standard deviation of the selected skin color model; and
adjust the skin color region according to the target color data.

12. The device according to claim 11, wherein the processor is further configured to:
calculate a difference between the original mean value and a preset mean value of each of the one or more preset skin color models; and
select the preset skin color model from the one or more preset skin color models, the difference between the preset mean value of the selected skin color model and the original mean value being smallest.

13. The device according to claim 11, wherein the processor is further configured to:
calculate an Euclidean distance between the original mean value and the preset mean value of each of the one or more preset skin color models; and
select the preset skin color model from the one or more preset skin color models, the Euclidean distance between the preset mean value of the selected skin color model and the original mean value being smallest.

14. The device according to claim 11, wherein the original color data is YUV data, and the processor is further configured to:
determine, for each pixel in the skin color region, the target color data of the pixel according to original color data of the pixel, the original mean value, and the original standard deviation, and the preset mean value and the preset standard deviation of the selected skin color model based on the following equations:
$${Y}^{*} = {meanY}_{iType} + \frac{{deltaY}_{iType} * ( Y - meanY )}{deltaY} ;$$
$${U}^{*} = {meanU}_{iType} + \frac{{deltaU}_{iType} * ( U - meanU )}{deltaU} ; and$$
$${V}^{*} = {meanV}_{iType} + \frac{{deltaV}_{iType} * ( V - meanV )}{deltaV} ;$$
wherein the original color data of the pixel is represented by (̅Y̅,̅U̅,̅V̅)̅, Y is a value of the original color data on a dimension Y in a YUV space, U is a value of the original color data on a dimension U in the YUV space, and V is a value of the original color data on a dimension V in the YUV space;
the target color data of the pixel is represented by (̅Y̅*̅,̅U̅*̅,̅V̅*̅)̅, Y* is a value of the target color data on the dimension Y in the YUV space, U* is a value of the target color data on the dimension U in the YUV space, and V* is a value of the target color data on the dimension V in the YUV space;
the original mean value is represented by (̅m̅e̅a̅n̅Y̅,̅m̅e̅a̅n̅U̅,̅m̅e̅a̅n̅V̅)̅, meanY is a value of the original mean value on the dimension Y in the YUV space, meanU is a value of the original mean value on the dimension U in the YUV space, and meanV is a value of the original mean value on the dimension V in the YUV space;
the original standard deviation is represented by (̅d̅e̅l̅t̅a̅Y̅,̅d̅e̅l̅t̅a̅U̅,̅d̅e̅l̅t̅a̅V̅)̅, deltaY is a value of the original standard deviation on the dimension Y in the YUV space, deltaU is a value of the original standard deviation on the dimension U in the YUV space, and deltaV is a value of the original standard deviation on the dimension V in the YUV space;
the preset mean value of the selected skin color model is represented by (̅m̅e̅a̅n̅Y̅_̅{̅i̅T̅y̅p̅e̅}̅,̅m̅e̅a̅n̅U̅_̅{̅i̅T̅y̅p̅e̅}̅,̅m̅e̅a̅n̅V̅_̅{̅i̅T̅y̅p̅e̅}̅)̅, meanY_{iType} is a value of the preset mean value on the dimension Y in the YUV space, meanU_{iType} is a value of the preset mean value on the dimension U in the YUV space, and meanV_{iType} is a value of the preset mean value on the dimension V in the YUV space; and
the preset standard deviation of the selected skin color model is represented by (̅d̅e̅l̅t̅a̅Y̅_̅{̅i̅T̅y̅p̅e̅}̅,̅d̅e̅l̅t̅a̅U̅_̅{̅i̅T̅y̅p̅e̅}̅,̅d̅e̅l̅t̅a̅V̅_̅{̅i̅T̅y̅p̅e̅}̅)̅, deltaY_{iType} is a value of the preset standard deviation on the dimension Y in the YUV space, deltaU_{iType} is a value of the preset standard deviation on the dimension U in the YUV space, and deltaV_{iType} is a value of the preset standard deviation on the dimension V in the YUV space.

15. The device according to claim 14, wherein the processor is further configured to:
adjust the original color data of each pixel in the skin color region to be the target color data of each pixel.

16. The device according to claim 11, wherein the processor is further configured to:
establish the one or more preset skin color models including a first preset skin color model, a second preset skin color model, a third preset skin color model, a fourth preset skin color model, a fifth preset skin color model, and a sixth preset skin color model, wherein:
a preset mean value and a preset standard deviation of the first preset skin color model are obtained by performing a statistical calculation on color data of sample images of light white people;
a preset mean value and a preset standard deviation of the second preset skin color model are obtained by performing a statistical calculation on color data of sample images of dark white people;
a preset mean value and a preset standard deviation of the third preset skin color model are obtained by performing a statistical calculation on color data of sample images of light yellow people;
a preset mean value and a preset standard deviation of the fourth preset skin color model are obtained by performing a statistical calculation on color data of sample images of dark yellow people;
a preset mean value and a preset standard deviation of the fifth preset skin color model are obtained by performing a statistical calculation on color data of sample images of light black people; and
a preset mean value and a preset standard deviation of the sixth preset skin color model are obtained by performing a statistical calculation on color data of sample images of dark black people.

17. The device according to claim 12, wherein the processor is further configured to:
establish the one or more preset skin color models including a first preset skin color model, a second preset skin color model, a third preset skin color model, a fourth preset skin color model, a fifth preset skin color model, and a sixth preset skin color model, wherein:
a preset mean value and a preset standard deviation of the first preset skin color model are obtained by performing a statistical calculation on color data of sample images of light white people;
a preset mean value and a preset standard deviation of the second preset skin color model are obtained by performing a statistical calculation on color data of sample images of dark white people;
a preset mean value and a preset standard deviation of the third preset skin color model are obtained by performing a statistical calculation on color data of sample images of light yellow people;
a preset mean value and a preset standard deviation of the fourth preset skin color model are obtained by performing a statistical calculation on color data of sample images of dark yellow people;
a preset mean value and a preset standard deviation of the fifth preset skin color model are obtained by performing a statistical calculation on color data of sample images of light black people; and
a preset mean value and a preset standard deviation of the sixth preset skin color model are obtained by performing a statistical calculation on color data of sample images of dark black people.

18. The device according to claim 13, wherein the processor is further configured to:
establish the one or more preset skin color models including a first preset skin color model, a second preset skin color model, a third preset skin color model, a fourth preset skin color model, a fifth preset skin color model, and a sixth preset skin color model, wherein:
a preset mean value and a preset standard deviation of the first preset skin color model are obtained by performing a statistical calculation on color data of sample images of light white people;
a preset mean value and a preset standard deviation of the second preset skin color model are obtained by performing a statistical calculation on color data of sample images of dark white people;
a preset mean value and a preset standard deviation of the third preset skin color model are obtained by performing a statistical calculation on color data of sample images of light yellow people;
a preset mean value and a preset standard deviation of the fourth preset skin color model are obtained by performing a statistical calculation on color data of sample images of dark yellow people;
a preset mean value and a preset standard deviation of the fifth preset skin color model are obtained by performing a statistical calculation on color data of sample images of light black people; and
a preset mean value and a preset standard deviation of the sixth preset skin color model are obtained by performing a statistical calculation on color data of sample images of dark black people.

19. The device according to claim 14, wherein the processor is further configured to:
establish the one or more preset skin color models including a first preset skin color model, a second preset skin color model, a third preset skin color model, a fourth preset skin color model, a fifth preset skin color model, and a sixth preset skin color model, wherein:
a preset mean value and a preset standard deviation of the first preset skin color model are obtained by performing a statistical calculation on color data of sample images of light white people;
a preset mean value and a preset standard deviation of the second preset skin color model are obtained by performing a statistical calculation on color data of sample images of dark white people;
a preset mean value and a preset standard deviation of the third preset skin color model are obtained by performing a statistical calculation on color data of sample images of light yellow people;
a preset mean value and a preset standard deviation of the fourth preset skin color model are obtained by performing a statistical calculation on color data of sample images of dark yellow people;
a preset mean value and a preset standard deviation of the fifth preset skin color model are obtained by performing a statistical calculation on color data of sample images of light black people; and
a preset mean value and a preset standard deviation of the sixth preset skin color model are obtained by performing a statistical calculation on color data of sample images of dark black people.

20. A non-transitory computer-readable storage medium having instructions stored therein which, when executed by a processor of a device, cause the device to perform a method for adjusting a skin color of an image, the method comprising:
identifying a skin color region of the image;
performing a statistical calculation on original color data of pixels in the skin color region to obtain an original mean value and an original standard deviation of the original color data of the pixels in the skin color region;
selecting a preset skin color model from one or more preset skin color models each representing one skin color type, according to the original mean value and a preset mean value of each of the one or more preset skin color models;
determining target color data according to the original color data, the original mean value, the original standard deviation, and the preset mean value and a preset standard deviation of the selected skin color model; and
adjusting the skin color region according to the target color data.
